(19) United States
(12) Patent Application Publication
(10) Pub. No.: US 2003/0139291 A1
(43) Pub. Date: Jul. 24, 2003

(54) Absorbent composites having cooling effect

(75) Inventor: Jian Qin, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/005,299

(22) Filed: Dec. 4, 2001

(51) Int. Cl. B01J 20/26

(52) U.S. Cl. 502/402

(57) ABSTRACT

An absorbent composition including a water-swellable, water-insoluble absorbent material and a cooling compound, wherein the cooling compound has an endothermic effect, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition. Also, a disposable absorbent product including a liquid-permeable topsheet, a liquid-impermeable backsheet attached to the topsheet, and an absorbent composition positioned between the topsheet and the backsheet, wherein the absorbent composition includes a water-swellable, water-insoluble absorbent material; and a cooling compound, wherein the cooling compound has an endothermic effect, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

### BACKGROUND OF THE INVENTION

The present invention relates to disposable absorbent products incorporating absorbent materials. The invention particularly concerns producing a cooling effect in a disposable absorbent product by combining an absorbent material and a cooling compound.

In some prior art applications, a cooling product is produced by separating reactive elements in a medical pad, including a mechanism to break the separation between the elements to allow a reaction. Such cooling pads either contain no absorbent material, or maintain a physical barrier between the cooling elements and the absorbent material.

Other prior art applications employ an endothermic composition to achieve a cooling effect, but contain no superabsorbent polymer (SAP).

In general, current commercial available superabsorbents, whether they are Na-acrylate based or isobutylene maleic anhydrate copolymer based, and whether they are in particulate form or fiber form, generate heat upon saturation with urine or saline. In other words, disposable absorbent products, such as baby diapers or training pants, will have a slight temperature increase when the superabsorbent in such products is insulted by urine. This is because hydration of the superabsorbent compositions is an exothermic reaction that releases energy to the environment and causes a temperature rise. Such temperature rise is too small to be felt by a wearer unless the superabsorbent content of the product is extremely high.

### SUMMARY OF THE INVENTION

In some disposable absorbent products, such as child training pants, it is desirable that the products be able to give the wearer a signal when the wearer is urinating. One possible signal is to produce a significant reduction in the local temperature. Such a reduction provides the wearer with an instant uncomfortable but non-harmful cooling effect. Frequent experiences with such cooling signals promote awareness of urination in the wearer and educate the wearer to the indications of a need for urination to promote a sense of prevention when urination is imminent.

Previous attempts to employ a reduction in local temperature in absorbent products using a cooling compound having an endothermic effect have not been able to avoid a significant reduction in absorbency due to the salt effect. Commercially available particulate superabsorbents are a crosslinked sodium polyacrylate, an anionic polymer. Such a polyelectrolyte-based crosslinked polymer in general exhibits a very high absorbency in water in comparison to its absorbency in a salt-containing aqueous fluid, such as saline or urine, due to an osmotic effect. Total absorbency of a polyelectrolyte gel is a function of the ionic concentration difference between the gel network on the inside and the saline on the outside. Any increase in salt concentration in the saline or urine will reduce the difference, further reducing total absorbency. For example, one gram of commercially available particulate sodium polyacrylate-based superabsorbent, such as Stockhausen FAVOR® 880, can absorb about 200 grams of water but only about 40 grams of 0.9 wt % NaCl saline. When the salt concentration of a salt-containing fluid increases, a superabsorbent's absorbency of such saline is dramatically reduced. This type of absorbency reduction due to the salt effect will be enhanced when a superabsorbent material is tested in an unfavorable situation, such as under external load, or where saline is wicked against gravity. When one skilled in the art applies an endothermic salt into an absorbent composition comprising a commercially available superabsorbent, a cooling effect can only be achieved at the expense of a significant reduction in absorbency. The endothermic salt produces cooling when it is dissolving while the dissolution of the salt significantly increases overall salt concentration. A cooling effect can be achieved only when a sufficient amount of endothermic salt is used. That is why only non-absorbent compositions have used endothermic salts as cooling agents in the prior art.

In response to the difficulties and problems discussed above, an absorbent composition includes an absorbent material and a cooling compound that is able to both reduce the environment temperature upon its dissolution in an aqueous solution, such as urine or saline, as well as maintain the absorbency of the absorbent material. Such an absorbent composition, when used in a disposable absorbent product such as a disposable training pant, can provide both high absorbency of bodily fluid and a sufficient reduction in the absorbent's temperature, and thus skin temperature, upon wetting. The absorbent composition disclosed by this invention comprises a non-neutralized but neutralizable crosslinked polymer and a neutralizing and endothermic agent. The non-neutralized but neutralizable crosslinked polymer can be either acidic, such as crosslinked polyacrylic acid, or basic, such as crosslinked polyvinyl amine. Acidity or basicity of the neutralizing and endothermic agent is dependent upon that of the crosslinked polymer. For example, when an acidic crosslinked polymer is selected, the neutralizing and endothermic agent has to be basic, and vice versa. This reduction in skin temperature creates awareness in the wearer of the need for urination. This awareness allows such compositions to be used for training purposes.

In one aspect, the invention provides an absorbent composition including a water-swellable, water-insoluble absorbent material and a cooling compound, wherein the cooling compound has an endothermic effect, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

In another aspect, the invention provides a disposable absorbent product including a liquid-permeable topsheet, a liquid-impermeable backsheet attached to the topsheet, and an absorbent composition positioned between the topsheet and the backsheet, wherein the absorbent composition includes a water-swellable, water-insoluble absorbent material; and a cooling compound, wherein the cooling compound has an endothermic effect, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

In another aspect, the invention provides a method for producing an absorbent composition capable of exhibiting a cooling effect, the method including selecting a water-swellable, water-insoluble absorbent material; selecting a cooling compound having an endothermic effect; and combining the absorbent material and the cooling compound to form the absorbent composition such that the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

In yet another aspect, the invention provides an absorbent composition including a superabsorbent material and a sufficient amount of cooling compound such that the absorbent composition is adapted to provide a cooling effect in at least a portion of the composition while absorbing aqueous liquid.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the containers of the invention. Together with the description, the drawings serve to explain the various aspects of the invention.

### BRIEF DESCRIPTION OF THE DRAWINGS

The present invention will be more fully understood and further advantages will become apparent when reference is made to the following detailed description of the invention and the accompanying drawings. The drawings are merely representative and are not intended to limit the scope of the claims.

FIG. 1 representatively shows a schematic view of a temperature measurement apparatus;

FIG. 2 representatively shows a schematic view of an apparatus used to measure a cooling effect in a composite; and

### DETAILED DESCRIPTION OF THE INVENTION

The present invention is directed at solving problems related to providing an absorbent product with a cooling effect. The present invention provides an absorbent composition comprising an absorbent material and a cooling compound that is able to both reduce the environmental temperature upon its dissolution in an aqueous solution, such as urine or saline, as well as maintain the absorbency of the absorbent material.

As used herein the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configuration of the material. These configurations include, but are not limited to isotactic, syndiotactic and random symmetries.

As used herein the term “cooling effect” generally refers to a temperature decrease noticeable to the wearer of an absorbent article. In general, the cooling effect will be effected by a certain temperature reduction of a certain duration, given a certain insult, with a temperature reduction of greater magnitude requiring a shorter duration to produce a cooling effect, and vice versa. Generally, a larger insult will yield a greater temperature reduction. More specifically, a cooling effect may be achieved by a temperature reduction of two degrees Celsius for a duration of about one minute, given an insult of approximately 10 cubic centimeters. Greater temperature reductions requiring a shorter duration, and lesser temperature reductions requiring a longer duration are also achievable. One skilled in the art can manipulate the properties of the absorbent article to produce a desired temperature reduction of a given duration given an expected insult.

As used herein, the term “disposable absorbent product” generally includes, but is not limited to, diapers, training pants, absorbent underpants, adult incontinence products, and feminine hygiene products.

As used herein, the term “particles” means any geometric or non-geometric form such as, but not limited to, spherical grains, cylindrical fibers or strands, flat surfaces or roughened surfaces, sheets, ribbons, strings, strands, or the like. When used in an absorbent structure, the particles can be loosely formed into a shaped structure or compressed into a shaped form.

As used herein, the term “superabsorbent” means a water-swellable, water-insoluble polymer. The acronym SAP refers to a superabsorbent polymer. The water-swellable, water-insoluble polymer to a large extent needs to provide the absorbent composition with its liquid-absorbing capacity. As such, the water-swellable, water-insoluble polymer needs to be effective to provide a desired amount of liquid-absorbing capacity to the absorbent composition. The term “water-swellable, water-insoluble” is meant to refer to a material that, when exposed to an excess of water, swells to its equilibrium volume but does not dissolve into the solution. As such, a water-swellable, water-insoluble material generally retains its original identity or physical structure, but in a highly expanded state, during the absorption of the water and, thus, must have sufficient physical integrity to resist flow and fusion with neighboring particles. A superabsorbent generally has an absorbent capacity of at least 10 grams of 0.9 wt % NaCl saline solution per gram of superabsorbent.

As used herein, a material will be considered to be “water soluble” when it substantially dissolves in excess water to form a solution, thereby losing its initial, typically particulate, form and becoming essentially molecularly dispersed throughout the water solution. As a general rule, a water-soluble material will be free from a substantial degree of crosslinking, as crosslinking tends to render a material water insoluble.

One property of the water-swellable, water-insoluble polymer that is relevant to its effectiveness in providing a desired amount of liquid-absorbing capacity to the absorbent structure is its molecular weight. In general, a water-swellable, water-insoluble polymer with a higher molecular weight will exhibit a higher liquid-absorbing capacity as compared to a water-swellable, water-insoluble polymer with a lower molecular weight.

The water-swellable, water-insoluble polymer useful in the absorbent structure may generally have a wide range of molecular weights. A water-swellable, water-insoluble polymer having a relatively high molecular weight is often beneficial for use in the present invention. Nonetheless, a wide range of molecular weights is generally suitable for use in the present invention. Water-swellable, water-insoluble polymers suitable for use in the present invention will beneficially have a weight average molecular weight greater than about 100,000, more beneficially greater than about 200,000, suitably greater than about 500,000, more suitably greater than about 1,000,000, and up to about 10,000,000. Methods for determining the molecular weight of a polymer are known to those skilled in the art.

It is sometimes more convenient to express the molecular weight of a polymer in terms of its viscosity in a 1.0 weight percent aqueous solution at 25° C., wherein the polymer is water-soluble. Polymers suitable for use in the present invention will suitably have a viscosity in a 1.0 weight percent aqueous solution at 25° C. of from about 100 centipoise (100 mPa.s) to about 80,000 centipoise (80,000 mPa.s), more suitably from a bout 500 centipoise (500 mPa.s) to about 80,000 centipoise (80,000 mPa.s), and most suitably from about 1,000 centipoise (1,000 mPa.s) to about 80,000 centipoise (80,000 mPa.s).

The water-swellable, water-insoluble polymer useful in the absorbent composition will generally be crosslinked. The amount of crosslinking should generally be above a minimum amount sufficient to make the polymer water-insoluble but also below some maximum amount so as to allow the polymer to be sufficiently water swellable so that the water-swellable, water-insoluble polymer absorbs a desired amount of liquid.

Crosslinking of the polymer may generally be achieved by either of two different types of crosslinking agents. The first type of crosslinking agent is a polymerizable crosslinking agent. Suitable polymerizable crosslinking agents are generally reactive to the monomer or monomers used to prepare the polymer and, thus, generally comprise at least two functional groups that are capable of reacting with the monomers. Examples of suitable polymerizable crosslinking agents include ethylenically unsaturated monomers, such as N,N′-methylene bis-acrylamide, for free radical polymerization and polyamines or polyols for condensation polymerization.

The second type of crosslinking agent is a latent crosslinking agent. Latent crosslinking agents generally can be either polymerizable or non-polymerizable. The non-polymerizable crosslinking agents generally do not take part in the overall polymerization process but, instead, are reactive to the polymer at a later point in time when a proper crosslinking condition is provided. The polymerizable crosslinking agents do take part in the overall polymerization process but generally do not cause intermolecular crosslinking. The intermolecular crosslinking generally only occurs at a later point in time when a proper crosslinking condition is provided. Suitable post treatment conditions to induce intermolecular crosslinking include using heat treatment, such as a temperature above about 60° C., exposure to ultraviolet light, exposure to microwaves, steam or high humidity treatment, high pressure treatment, or treatment with an organic solvent.

Latent non-polymerizable crosslinking agents suitable for use in the present invention are generally water-soluble. A suitable latent non-polymerizable crosslinking agent is an organic compound having at least two functional groups or functionalities capable of reacting with any carboxyl, carboxylic acid, amino, or hydroxyl groups on the polymer. Examples of suitable latent non-polymerizable crosslinking agents include, but are not limited to, diamines, polyamines, diols, polyols, polycarboxylic acids, and polyoxides. Another suitable latent non-polymerizable crosslinking agent comprises a metal ion with more than two positive charges, such as Al³⁺, Fe³⁺, Ce³⁺, Ce⁴⁺, Ti⁴⁺, Zr⁴⁺, and Cr³⁺.

When the polymer is a cationic polymer, a suitable latent non-polymerizable crosslinking agent is a polyanionic material such as sodium polyacrylate, carboxymethyl cellulose, or polyphosphate.

Latent polymerizable crosslinking agents suitable for use in the present invention are generally water soluble and reactive to the monomer or monomers used to prepare the water-swellable, water-insoluble polymer. The latent polymerizable crosslinking agents generally contain at least one functional group or functionality capable of reacting with the monomer or monomers and at least one functional group or functionality capable of reacting with any carboxyl, carboxylic, amino, or hydroxyl groups on the polymer. Examples of suitable latent polymerizable crosslinking agents include, but are not limited to, ethylene glycol vinyl ether, amino propanol vinyl ether, diethylamino ethyl methacrylate, allylamine, methylallylamine, ethylallylamine.

Co-pending application Ser. No. 08/759,108, filed Dec. 2, 1996, describes an absorbent composition with either an acidic absorbent gel and a second basic material, or a basic absorbent gel and an acidic second material. The examples in that co-pending application are all exothermic. For example, if polyacrylic acid gel and sodium carbonate are used in a diaper, the combination does not have cooling effect. On the contrary, the combination releases heat and is thus exothermic.

In some disposable absorbent products, such as child training pants, it is desirable that the products be able to give the wearer a signal when the wearer is urinating. One possible signal is to produce a significant reduction in the local temperature. An example of such a cooling effect including the tradeoff between temperature reduction and duration of temperature reduction is discussed above. Such a reduction provides the wearer with an instant uncomfortable but non-harmful cooling effect. Frequent experiences with such cooling signals promote awareness of urination in the wearer and educate the wearer to the indications of a need for urination to promote a sense of prevention when urination is imminent. Because the cooling effect can be uncomfortable for the wearer of the disposable absorbent product, the wearer will seek, either consciously or unconsciously, to avoid the cooling effect in the future. The wearer will be induced to recognize internal indicators of pending urination, for example, and to respond accordingly.

To produce such a cooling or endothermic effect, a composition includes at least an absorbent material and a chemical compound that has an endothermic effect with water upon contact with an aqueous solution. More importantly, such an endothermic effect must be greater in magnitude than the exothermic heat of hydration of the absorbent material such that overall effect from the composition of the absorbent material and the chemical compound is endothermic when exposed to an aqueous solution, such as urine or saline. For the purposes of this invention, the endothermic effect of a chemical compound includes the heat of hydration, which is the heat associated with the hydration of water molecules onto the surface of a substance, and the heat of solution, which is the heat absorbed when a substance is dissolved in a solvent. The heat of hydration is typically a more surface contact-related effect and is typically a faster energy exchange. The heat of solution is typically larger in magnitude and lasts longer due to dissolution kinetics; as such, the heat of solution is discussed more extensively below. The endothermic effect may also include a chemical reaction between components in which heat is absorbed in a chemical reaction in order to generate a new substance.

Many salts are capable of producing an endothermic effect when combined with an aqueous solution. Table 1 lists the molar enthalpy of some common univalent electrolytes. This molar enthalpy is the enthalpy change when one mole of solute in its standard state is dissolved in an infinite amount of water. Values are given in kilojoules per mole at 25° C. Positive enthalpy values represent an endothermic heat of solution, or absorption of heat from the environment and thus a cooling effect. Negative enthalpy values represent an exothermic heat of solution, or a release of heat to the environment and thus a heating effect. Absolute values of the molar enthalpies represent the magnitude of the cooling or heating effects.

TABLE 1

| | ΔₛₒₗH° | | ΔₛₒₗH° | | ΔₛₒₗH° |
|---|---|---|---|---|---|
| Solute | kJ/mol | Solute | kJ/mol | Solute | kJ/mol |
| HF | −61.50 | NaCl | 3.88 | RbOH | −62.34 |
| HCl | −74.84 | NaBr2H₂O | 18.64 | RbCl | 17.28 |
| HClO₄ | −88.76 | NaBrO₃ | 26.90 | RbClO₃ | 47.74 |
| HClO₄.H₂O | −32.95 | NaI.2H₂O | 16.13 | RbClO₄ | 56.74 |
| HlO₃ | 8.79 | NaIO₃ | 20.29 | RbBr | 21.88 |
| CH₃COOH | −1.51 | NaNO₂ | 13.89 | RbBrO₃ | 48.95 |
| | | NaNO₃ | 20.50 | Rbl | 25.10 |
| NH₃ | −30.50 | NaC₂H₃O₂ | −17.32 | RbNO₃ | 36.48 |
| NH₄Cl | 14.78 | NaC₂H₃O₂ 3H₂O | 19.66 | | |
| NH₄IO₃ | 31.80 | NaCN 2H₂O | 18.58 | CsOH | −71.55 |
| NH₄NO₃ | 25.69 | NaCNO | 19.20 | CsCl | 17.78 |
| N(CH₃)₄I | 42.07 | | | CsClO₄ | 55.44 |
| | | KOH | −57.61 | CsBr | 25.98 |
| LiOH | −23.56 | KCl | 17.22 | CsBrO₃ | 50.46 |
| LiCl | −37.03 | KClO₃ | 41.38 | Csl | 33.35 |
| LiClO₄ | −26.55 | KClO₄ | 51.04 | CsNO₃ | 40.00 |
| LiClO₄.3H₂O | 32.61 | Kl | 20.33 | | |
| | | KNO₃ | 34.89 | | |
| NaOH | −44.51 | KMnO₄ | 43.56 | | |

Note:
from CRC Handbook of Chemistry and Physics, 80^{th} Edition, Ed. By David R. Lide, CRC Press.

To have a significant cooling effect, it is desirable to select a chemical compound having an endothermic effect sufficient to overcome the exothermic effect of SAP heat of hydration as well as to absorb enough heat from the environment to cause a sensible temperature drop to achieve a cooling effect. It is desirable to select a chemical compound having an enthalpy at least greater than 5 kJ/mol, beneficially greater than 10 kJ/mol, suitably greater than 15 kJ/mol.

In selecting a cooling compound, two factors other than an endothermic effect need to be considered. These are (1) the potential for skin irritation by the compounds, and (2) the impact on absorbency of a superabsorbent due to the dissolution of ionic compounds. To reduce the potential for skin irritation of the wearer of a disposable absorbent product, the pH of a solution containing the combination of the absorbent and the cooling compound must be neutral or slightly acidic, ideally in a range from 4 to 7. For example, when the superabsorbent is a neutralized polymer, such as sodium polyacrylate, both ammonium chloride NH₄Cl and potassium chloride KCl are potential cooling compounds that have an endothermic enthalpy of solution. The former, however, when combined in a solution with a superabsorbent, will result in a strongly acidic solution having a pH less than 4. Conversely, the latter, when combined in a solution with a superabsorbent, will result in a neutral solution having a pH of approximately 7. Therefore, for the purpose of preventing skin irritation, KCl is preferable to NH₄Cl as a cooling compound for use in a disposable absorbent product including a neutralized polymer.

On the other hand, when a non-neutralized absorbent polymer, such as polyvinyl amine gel, is used, the cooling agent has to be both neutralizable and endothermic. In this case, ammonium chloride NH₄Cl will be a better choice than potassium chloride KCl. Acidic NH₄Cl is able to neutralize the polyvinyl amine gel to result an overall neutral pH value, while KCl is unable to neutralize the basic polyvinyl amine gel to result in an overall basic pH value. Therefore, for the purpose of preventing skin irritation, NH₄Cl is preferable to KCl as a cooling compound for use in a disposable absorbent product including a non-neutralized polymer.

Potential chemical compounds to be used as cooling compounds include, but are not limited to, potassium chloride, sodium acetate trihydrate, ammonium nitrate, ammonium chloride, ammonium iodate, tetramethylammonium iodide, lithium perchlorate trihydrate, sodium cyanide dihydrate, sodium cyanate, potassium perchlorate, potassium nitrate, potassium iodide, potassium iodate, potassium permanganate, rubidium nitrate, rubidium iodide, cesium iodide, cesium chloride, cesium bromide, cesium perchlorate, cesium nitrate.

The impact on absorbency of an absorbent, and particularly a superabsorbent, is related to the dissolution of the cooling chemical compound that can cause a reduction of fluid absorbency of the superabsorbent material. High absorbency of a superabsorbent material is due to high charge density inside the superabsorbent gel that creates an osmotic pressure, forcing the aqueous fluid outside of the superabsorbent gel to diffuse into the gel. Any increase in electrolyte concentration in the aqueous fluid outside of the superabsorbent gel will significantly reduce such pressure and further reduce the absorbency. Adding a cooling chemical compound into the absorbent product may reduce the overall urine absorbency if the compound is completely dissolved in the urine. The solution to such concern is to use an in-situ neutralized superabsorbent. Co-pending application Ser. No. 08/759,108, filed Dec. 2, 1996, discloses an absorbent composition comprising either (1) a water-swellable, water-insoluble acidic polymer gel and a basic second material; or (2) a water-swellable, water-insoluble basic polymer gel and an acidic second material. The absorbent polymer gels in the composition have a low initial absorbency but a very high absorbency when they are fully neutralized by the second materials.

Similarly, this improvement in absorbency in conjunction with a cooling effect can be achieved where a cooling compound is properly selected to achieve both a cooling effect and a neutralization of the absorbent polymer gel. For example, when polyacrylic acid gel, which has an acidic pH, is used as the absorbent polymer gel, sodium acetate trihydrate NaC₂H₃O₂ 3H₂O can be used as the neutralizing agent because sodium acetate trihydrate NaC₂H₃O₂ 3H₂O has a basic pH. Sodium acetate trihydrate NaC₂H₃O₂ 3H₂O has an endothermic enthalpy of 19.66 kJ/mol. Another example is a mixture of crosslinked polyvinyl amine and ammonium nitrate NH₄NO₃. Polyvinyl amine gel is a basic absorbent gel which can be neutralized by the acidic ammonium nitrate NH₄NO₃. Ammonium nitrate NH₄NO₃ has an endothermic enthalpy of 25.69 kJ/mol.

In one embodiment of the present invention, the water-swellable, water-insoluble polymer useful in the absorbent structure will be acidic in nature. As used herein, an “acidic” material is intended to refer to a material that may act as an electron acceptor and which, in an aqueous solution, exhibits a pH between about 0 to 7. Suitably, the pH is measured at about 25° C. Methods of measuring the pH of an aqueous solution are well known in the art.

In general, acidic, water-swellable, water-insoluble polymers useful in the absorbent structure may be either strongly or weakly acidic in nature. In general, an acidic, water-swellable, water-insoluble polymer that is strongly acidic will exhibit a pKa less than about 2. In general, an acidic, water-swellable, water-insoluble polymer that is weakly acidic will exhibit a pKa that is greater than about 2. As such, acidic, water-swellable, water-insoluble polymers useful in the absorbent structure may exhibit a broad range of pKa values, but will beneficially have a pKa between about 0 to about 12, more beneficially between about 2 to about 10, and suitably between about 3 to about 7. As will be appreciated by one skilled in the art, a monobasic acid will generally have a single pKa value whereas multibasic acids will generally have multiple pKa values. Unless indicated otherwise herein, a reference to the pKa value of a multibasic acid is intended to refer to the pKa₁ value of the multibasic acid.

Suitable acidic, water-swellable, water-insoluble polymers will include functional groups that are capable of acting as acids. Such functional groups include, but are not limited to, carboxyl groups, sulfonic groups, sulphate groups, sulfite groups, and phosphate groups. Suitably, the functional groups are carboxyl groups. Generally, the functional groups are attached to a crosslinked base polymer. Suitable base polymers include polyacrylamides, polyvinyl alcohols, ethylene maleic anhydride copolymer, polyvinylethers, polyacrylamido methylpropane sulfonic acid, polyacrylic acids, polyvinylpyrrolidones, polyvinylmorpholines, and copolymers or mixtures of the preceding polymers. Natural based polysaccharicle polymers may also be used and include carboxymethyl celluloses, carboxymethyl starches, hydroxypropyl celluloses, algins, alginates, carrageenans, acrylic grafted starches, acrylic grafted celluloses, and copolymers or mixtures of the preceding polymers. Synthetic polypeptides can also be used such as polyaspartic acid and polyglutamic acid.

The acidic, water-swellable, water-insoluble polymer generally needs to be in its free acid form in order to be neutralized by a basic cooling compound to eliminate salt poisoning effect. In general, it is desired that the acidic, water-swellable, water-insoluble polymer beneficially have at least about 50 molar percent, more beneficially at least about 70 molar percent, suitably at least about 80 molar percent, more suitably at least about 90 molar percent, and most suitably substantially about 100 molar percent of its acidic functional groups in free acid form. Alternatively, then, the acidic, water-swellable, water-insoluble polymer should not be substantially neutralized when used in the absorbent structure of the present invention. In general, it is desired that the acidic, water-swellable, water-insoluble polymer have a degree of neutralization of its acidic functional groups that is beneficially less than about 50 molar percent, more beneficially less than about 30 molar percent, suitably less than about 20 molar percent, more suitably less than about 10 molar percent, and most suitably substantially about 0 molar percent. Higher molar percent functional groups in free acid groups provide an opportunity to incorporate more basic cooling compound and further a more significant cooling effect, vice versa. Therefore, degree of neutralization can be used to control desired cooling effect.

In another embodiment of the present invention, the water-swellable, water-insoluble polymer useful in the absorbent structure will be basic in nature. As used herein, a “basic” material is intended to refer to a material that may act as an electron donor and which, in an aqueous solution, exhibits a pH between 7 to about 14. Suitably, the pH is measured at about 25° C. Methods of measuring the pH of an aqueous solution are well known in the art.

In general, basic, water-swellable, water-insoluble polymers useful in the absorbent structure may be either strongly or weakly basic in nature. In general, a basic, water-swellable, water-insoluble polymer that is strongly basic will exhibit a pKa greater than about 12. In general, a basic, water-swellable, water-insoluble polymer that is weakly basic will exhibit a pKa that is less than about 12. As such, basic, water-swellable, water-insoluble polymers useful in the absorbent structure may exhibit a broad range of pKa values, but will beneficially have a pKa between about 2 to about 14, more beneficially between about 4 to about 12, and suitably between about 7 to about 11. As will be appreciated by one skilled in the art, a monobasic base will generally have a single pKa value whereas multibasic bases will generally have multiple pKa values. Unless indicated otherwise herein, a reference to the pKa value of a multibasic base is intended to refer to the pKa₁ value of the multibasic base.

Suitable basic water-swellable, water-insoluble polymers will include functional groups that are capable of acting as bases. Such functional groups include, but are not limited to, primary, secondary, or tertiary amino groups, imino groups, imido groups, amido groups, and quaternary ammonium groups. Suitably the functional groups are primary amino groups or quaternary ammonium groups. Generally, the functional groups are attached to a crosslinked base polymer. Suitable base polymers include polyamines, polyethyleneimines, polyacrylamides, polyallylamine, polydiallyl dimethyl ammonium hydroxide, and polyquaternary ammoniums, and copolymers or mixtures thereof. Natural based polysaccharide polymers may also be used and include chitin and chitosan. Synthetic polypeptides can also be used such as polyasparagines, polyglutamines, polylysines, and polyarginines.

The basic, water-swellable, water-insoluble polymer generally needs to be in its free base form in order to be neutralized by an acidic cooling compound to eliminate salt poisoning effect. In general, it is desired that the basic, water-swellable, water-insoluble polymer beneficially have at least about 50 molar percent, more beneficially at least about 70 molar percent, suitably at least about 80 molar percent, more suitably at least about 90 molar percent, and most suitably substantially about 100 molar percent of its basic functional groups in free base form. Alternatively, then, the basic, water-swellable, water-insoluble polymer should not be substantially neutralized when used in the absorbent structure of the present invention. In general, it is desired that the basic, water-swellable, water-insoluble polymer have a degree of neutralization of its basic functional groups that is beneficially less than about 50 molar percent, more beneficially less than about 30 molar percent, suitably less than about 20 molar percent, more suitably less than about 10 molar percent, and most suitably substantially about 0 molar percent. Higher molar percent functional groups in free base groups provide an opportunity to incorporate more acidic cooling compound and further a more significant cooling effect, vice versa. Therefore, degree of neutralization can be used to control desired cooling effect.

When an acidic non-neutralized but neutralizable crosslinked absorbent polymer is used in absorbent composition, a basic neutralizing agent has to be used to ensure a high absorbency through neutralization between the two components in use condition. At the same time, this basic neutralizing agent has to be water-soluble and have an endothermic heat of solution. Examples of such basic neutralizing and cooling agents include, but are not limited to, sodium acetate trihydrate (NaC₂H₃O₂ 3H₂O), lithium acetate trihydrate (LiC₂H₃O₂.3H₂O), sodium cyanate (NaCNO), sodium cyanide dihydrate (NaCN.2H₂O) and potassium permanganate (KMnO₄). When a basic non-neutralized but neutralizable crosslinked absorbent polymer is used in absorbent composition, an acidic neutralizing agent has to be used to ensure a high absorbency through neutralization between the two components in use condition. At the same time, this acidic neutralizing agent has to be water-soluble and have an endothermic heat of solution. Examples of such acidic neutralizing and cooling agents include, but are not limited to, ammonium chloride (NH₄Cl), ammonium iodate (NH₄IO₃), ammonium nitrate (NH₄NO₃), and tetramethylammonium iodide (N(CH₃)₄I).

Placement of a cooling compound in an absorbent product does not necessarily need to be homogenous. Strategic or close-to-skin placement of the cooling compound can be more effective. For example, the cooling compound can be placed in a location close to the top layer of an absorbent product and/or near the urine insult zone, which is generally the area of the absorbent product first contacted by urine when the wearer urinates. Because the cooling effect need only be produced close to the skin of the wearer of the disposable absorbent product, such placement can minimize amount of the compound required to produce a significant sensation.

In alternative embodiments, the cooling effect can be enhanced by providing a composition with an endothermic effect in one portion of the disposable absorbent product, and by providing an absorbent with an exothermic hydration in another portion of the disposable absorbent product. The effect will be to cool one portion of the product and heat another portion, thus providing a greater temperature difference to be experienced by the wearer. The compound can be applied onto absorbent product components, such as diaper liner, surge, tissue, pulp fluff, or an absorbent core, and in many different forms, such as particulate, a coating, encapsulation, or a coform. A coform is produced by a fiber spinning process by incorporating a fiber with other components. One example is melt blown coform in which polyethylene is spun into fiber through a melt blown process and coformed with wood pulp fluff and/or superabsorbent particles.

It has been found that a single material or polymer, comprising both acidic and basic functional groups within its molecular structure, will not exhibit the desired absorbent properties and cooling effect described herein. This is believed to be because such acidic and basic functional groups within a single molecular structure will typically react with each other and might result in a neutralized polymer structure. As such, it generally is not possible to prepare the absorbent structure of the present invention by preparing a blend from an acidic (or basic) polymer and a basic (acidic) neutralizing/cooling agent or by preparing a molecular level dispersion, such as in an aqueous solution, of water-soluble acidic and basic materials since during such polymerization or molecular level dispersion the acidic and basic materials will typically react with each other and result in a neutralized material and a byproduct with no cooling effect. For example, when polyacrylic acid gel is mixed with sodium acetate trihydrate in the presence of water, sodium acetate trihydrate will react with polyacrylic acid to form sodium polyacrylate and acetic acid. The resulting compound, if placed in an absorbent product, will not exhibit a cooling effect upon saturation with urine because both sodium polyacrylate and acetic acid are not endothermic compounds. In some cases, it is desirable to have both an absorbent polymer gel and a cooling compound in one material, such as in one particle, to simplify the process of manufacturing. A composite particle comprising both components can be made by mixing two particulate components with an adhesive material in the presence of organic solvent. As long as no water is involved, the two components will not react with each other in the process of manufacturing and can be incorporated into any physical form.

The dissolution rate of the cooling compounds also affects the cooling effect. In general, fast dissolution produces a more significant temperature reduction in a short period of time, while slow dissolution produces a less significant but prolonged temperature reduction. To achieve fast dissolution, cooling compounds with more surface area or smaller particle size, a lower degree of crystallization, or a higher degree of solubility are preferred.

In general, it is desired that the absorbent composition exhibits a pH value that remains beneficially between 3 to 8, more beneficially between 4 to 7, and suitably between 4 to 6.5. When absorbent material is a neutralized crosslinked polymer, such as sodium polyacrylate, and a cooling compound is either acidic or basic, an acidic or basic pH may result due to an imbalance of acidic and basic functional groups between the two components of the absorbent composition. Similarly, when an acidic (or a basic) absorbent material and a basic (or acidic) cooling compound are selected for the absorbent composition, even at a one to one molar ratio, a pH value outside of the range between 3 to 8 can still occur due to the different ionization rates of the two components. To prevent the occurrence of an undesirable pH, either a chemical or a physical approach can be used. Such approaches include, but are not limited to (1) the use of a buffer agent, (2) a match of ionization rates, and (3) a match of acidity and basicity.

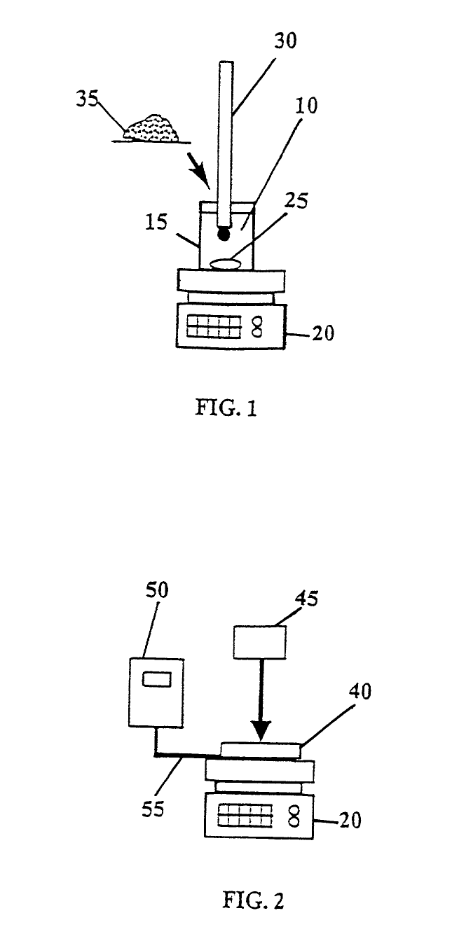

FIG. 1 illustrates a method for measuring the temperature of a solution. 50 grams of 0.9% NaCl saline 10 are added to a 100 ml glass beaker 15, and the beaker 15 is then place on a magnetic stirrer 20 (DATAPLATE Digital Hot Plate/Stirrer, Model No. PMC-731 from PMC Industries, Inc.). The plate temperature is set to 54° C. and the speed of the stirrer bar 25 is set to 300 rpm. With such settings, the temperature of the saline 10 in the beaker 15 is equilibrated at 37° C., as measured by a thermometer 30 with an accuracy of ±0.05° C. (Baxter Scientific Products thermometer, Model No. T 2030-2). When the temperature of the saline 10 is around 37° C. ±0.05° C., a sample 35 of absorbent and/or cooling compound is added to the beaker 15 and the temperature is monitored. The temperature generally either increases or decreases and then slowly returns to 37° C. Either the lowest or the highest temperature achieved is recorded as the measured temperature.

To measure the absorbency of a material, about 0.16 g of an absorbent composition sample is weighed and placed into a plastic sample cup consisting of a plastic cylinder having an inside diameter of 1 inch and an outside diameter of 1.25 inches. The cylinder is suitably formed from a clear material such as an acrylic resin commercially available under the designation LUCITE-brand resin. The bottom of the sample cup is formed by adhering a 100 mesh metal screen having 150 micron openings to the end of the cylinder by heating the screen above the melting point of the plastic and pressing the plastic cylinder against the hot screen to melt the plastic and bond the screen to the plastic cylinder. The sample is then covered with a plastic spacer disc. The disc, weighing 4.4 grams and having a diameter of about 0.995 inches, generates a pressure of about 0.01 psi and serves to protect the sample from being disturbed during the test. The disc also uniformly applies a load on the entire sample. The sample cup, with the material sample and the spacer disc, is then weighed to obtain its dry weight. The sample cup is then placed into a dish that contains about 25 ml of 0.9% NaCl saline. After one hour, the sample cup is taken out of the dish and placed on paper toweling to blot interstitial fluid. The blotting is continued by moving the cylinder to dry areas of the dry paper toweling until there is no fluid mark visible on the paper toweling. The sample cup is then weighed again to obtain its wet weight. The difference in weight of the sample cup between wet and dry conditions represents the total amount of fluid absorbed by the sample and is used to calculate free swell absorbency.

A Saturation Capacity test measures the capacity of an absorbent composite or product. A composite is cut to the preferred size and pressed to the preferred density. The dry weight of the composite is recorded. The composite is then placed in a 0.9 wt % NaCl solution for twenty minutes. The level of the NaCl solution is such that the composite is fully submerged. After twenty minutes, the composite is removed from the NaCl saline bath and placed horizontally on a screen to let drip for one minute. A pressure of 0.5 psi is applied evenly to the composite for five minutes. The wet weight of the composite is recorded. Saturation Capacity is calculated as follows:

$$Sat . Cap . ( g \text{/} g ) = \frac{WetWeight - DryWeight}{DryWeight}$$

### EXAMPLE 1

commercial superabsorbent powder, available from Stockhausen Inc. and designated as FAVOR 880, and a self-prepared polyacrylic acid gel powder (PAA) were prepared for temperature and absorbency tests and were designated as Component 1. Sodium acetate trihydrate (NaC₂H₃O₂.3H₂O), available from Aldrich Chemical Company, was also prepared for the temperature and absorbency tests, and was designated as Component 2. Co-pending application Ser. No. 08/759,108, filed Dec. 2, 1996, discloses a detailed procedure for preparing the polyacrylic acid gel. Both the FAVOR 880 superabsorbent powder and the polyacrylic acid gel have particle sizes ranging from 150 to 850 microns. The sodium acetate trihydrate has a particle size ranging from 500 to 5,000 microns. Various amounts and combinations of Components 1 and 2 were mixed into a saline solution, as demonstrated in Table 2. The temperature effects and absorbency of these mixtures were recorded. As expected, a mixture of Component 1 alone without a cooling compound was exothermic and resulted in an increase in the temperatures of the solutions. A mixture of both Component 1 and Component 2 was endothermic and resulted in a decrease in the temperatures of the solutions.

TABLE 2

| | | Saline Temp. | Saline Temp. | Temp. | Absorbency |
|---|---|---|---|---|---|
| Component | Component 2 | Before | After | Change | (g/g |
| 1 | CH₃COONa.3H₂O | Addition | Addition | (° C.) | polymer) |
| 5 g Favor | 0 g | 37.0° C. | 39.0° C. | +2.0° C. | 36.1 |
| 880 | | | | | |
| | 5 g | 37.0° C. | 33.0° C. | −4.0° C. | |
| 4 g Favor | 1 g | 37.0° C. | 36.5° C. | −0.5° C. | 33.9 |
| 880 | | | | | |
| 3 g Favor | 2 g | 37.0° C. | 35.5° C. | −1.5° C. | 30.0 |
| 880 | | | | | |
| 2 g Favor | 3 g | 37.0° C. | 34.5° C. | −2.5° C. | 26.9 |
| 880 | | | | | |
| 5 g PAA | 0 g | 37.0° C. | 37.5° C. | +0.5° C. | 6.4 |
| 4 g PAA | 1 g | 37.0° C. | 35.5° C. | −1.5° C. | 12.5 |
| 3 g PAA | 2 g | 37.0° C. | 35.0° C. | −2.0° C. | 20.8 |
| 2 g PAA | 3 g | 37.0° C. | 34.0° C. | −3.0° C. | 33.5 |

### EXAMPLE 2

Sodium acetate trihydrate (NaC₂H₃O₂.3H₂O), available from Aldrich Chemical Company, was used to measure the cooling effect resulting from its mixture with different ratios of 0.9% NaCl saline. As illustrated in Table 3, various amounts of sodium acetate trihydrate (NaC₂H₃O₂.3H₂O) were combined with various amounts of 0.9% NaCl saline. The temperature of the saline was measured before and after the addition of sodium acetate trihydrate (NaC₂H₃O₂.3H₂O), and the temperature change was calculated. It can be concluded that cooling effect is enhanced as the ratio of cooling compound to saline is increased. This result suggests that in a real absorbent product, the wearer will experience a stronger cooling effect with a higher ratio.

TABLE 3

| CH₃COONa.3H₂O | 0.9% NaCl | Saline Temp. | Saline Temp. | Temp. Change |
|---|---|---|---|---|
| (g) | Saline (g) | Before Addition | After Addition | (° C.) |
| 1.3 | 50 | 37.5° C. | 36.5° C. | −1.0° C. |
| 2.5 | 50 | 37.5° C. | 34.5° C. | −3.0° C. |
| 5.0 | 50 | 37.0° C. | 33.0° C. | −4.0° C. |
| 5.0 | 40 | 37.0° C. | 32.5° C. | −4.5° C. |
| 5.0 | 30 | 37.5° C. | 31.5° C. | −6.0° C. |

### EXAMPLE 3

A superabsorbent material, a cooling compound, and wood pulp fluff (CR1654), a fully bleached Southern pine kraft pulp produced by U.S. Alliance Coosa Pines Corporation, Alabama, were air laid into composites using an air-laying process. Both the superabsorbent material and the cooling compound were pre-screened to yield particle sizes ranging from 300 to 600 microns. The composites were densified to a density of approximately 0.2 g/cc by a CARVER-brand press, available from Carver, Inc. in Wabash, Ind., under the designation Model 2333 laboratory press, at room temperature under about 10,000 to 15,000 psi for about ten seconds. Disks 40 were made by punching the composites using a mold having a diameter of 2 inches. As illustrated in FIG. 2, the disks 40 were used for a cooling effect measurement. 0.9% NaCl saline 45, which was used to insult the composite disks 40, was weighed at a ratio of 10 grams saline 45 per gram of composite disk 40. The saline 45 was preheated to 37° C. and maintained at that temperature. A DIGI-SENSE thermocouple thermometer 50, Model No. 8529-00 available from Cole-Parmer Instrument Company, Chicago, Ill., was used to measure temperature. The tip of the thermocouple 55 contacted with the top of a magnetic stirrer 20, which kept the surface of the stirrer 20 at 37° C. The composites were also evaluated by the Saturation Capacity Test (described above). The results of the tests are illustrated in Table 4.

TABLE 4

| | | Composite Cooling Effect Measurement | | | | |
|---|---|---|---|---|---|---|
| | Composite | Composite | Saline | Temp. | Temp. | Saturation |
| | Composition | Weight | Insult | Before | After | Capacity |
| No. | (10″ × 15″) | (2″ Disk) | Amount | Insult | Insult | (g/g) |
| 1* | 10 g Favor 880 | 0.708 g | 7.08 g | 37° .C | 37° C. | 15.1 |
| | 17 g CR1654 | | | | | |
| 2 | 10 g Favor 880 | 0.854 g | 8.54 g | 37° C. | 35° C. | 12.5 |
| | 10 g CH₃COONa 3H₂O | | | | | |
| | 17 g CR1654 | | | | | |
| 3 | 8 g Polyacrylic acid | 0.908 g | 9.08 g | 37° C. | 34° C. | 11.4 |
| | 12 g CH₃COONa 3H₂O | | | | | |
| | 17 g CR1654 | | | | | |
| 4 | 8 g Polyacrylic acid | 0.971 g | 9.71 g | 37° C. | 33° C. | 15.8 |
| | 15 g CH₃COONa.3H₂O | | | | | |
| | 17 g CR1654 | | | | | |

Note:
*Not an example of this invention.

As demonstrated in these examples, a significant cooling effect can be demonstrated in the presence of a fluid insult while maintaining the absorbency of an absorbent material. The Saturation Capacities demonstrated in sample nos. 2-4 are 83 percent, 75 percent, and 105 percent, respectively, of the Saturation Capacity of sample no. 1, which was a sample without a cooling compound. As such, it is desirable and possible to produce an absorbent composition that demonstrates a significant cooling effect and that maintains a Saturation Capacity of preferably at least 70 percent of the Saturation Capacity of the absorbent material alone, of more preferably at least 90 percent of the Saturation Capacity of the absorbent material alone, and of most preferably at least 100 percent of the Saturation Capacity of the absorbent material alone.

Accordingly, the different aspects of the present invention can advantageously provide an absorbent composition comprising an absorbent material and a cooling compound that is able to both reduce the environment temperature upon its dissolution in an aqueous solution, such as urine or saline, as well as maintain the absorbency of the absorbent material. Such an absorbent composition, when used in a disposable absorbent product such as a disposable training pant, can provide both high absorbency of bodily fluid and a sufficient reduction in the absorbent's temperature, and thus skin temperature, upon wetting. This reduction in skin temperature creates awareness in the wearer of the need for urination. This awareness allows such compositions to be used for training purposes.

While the invention has been described in detail with respect to the specific aspects thereof, it will be appreciated that those skilled in the art, upon attaining an understanding of the foregoing, may readily conceive of alterations to, variations of, and equivalents to these aspects. Accordingly, the scope of the present invention should be assessed as that of the appended claims and any equivalents thereto.

What is claimed is:

1. An absorbent composition comprising:
a water-swellable, water-insoluble absorbent material; and
a cooling compound, wherein the cooling compound has an endothermic effect, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

2. The composition of claim 1, wherein the absorbent material is acidic, and wherein the cooling compound is a basic compound capable of neutralizing the acidic absorbent material.

3. The composition of claim 2, wherein the absorbent material has a pH ranging from 1 to 6.5, and wherein the absorbent composition has a pH ranging from 4 to 6.5.

4. The composition of claim 1, wherein the absorbent material is basic, and wherein the cooling compound is an acidic compound capable of neutralizing the basic absorbent material.

5. The composition of claim 4, wherein the absorbent material has a pH ranging from 7.5 to 13, and wherein the absorbent composition has a pH ranging from 4 to 6.5.

6. The composition of claim 1, wherein the absorbent material has a pH ranging from 6 to 7.5, and wherein the absorbent composition has a pH ranging from 4 to 6.5.

7. The composition of claim 1, wherein the absorbent composition has a pH ranging from 3 to 8.

8. The composition of claim 1, wherein the absorbent composition has a pH ranging from 4 to 7.

9. The composition of claim 1, wherein the absorbent composition exhibits an absorbent capacity of at least 70 percent of the absorbent capacity of the absorbent material.

10. The composition of claim 1, wherein the absorbent composition exhibits an absorbent capacity of at least 90 percent of the absorbent capacity of the absorbent material.

11. The composition of claim 1, wherein the absorbent composition exhibits an absorbent capacity at least equal to the absorbent capacity of the absorbent material.

12. The composition of claim 1, wherein the cooling compound is chosen from the group consisting of: potassium chloride, sodium acetate trihydrate, ammonium nitrate, ammonium chloride, ammonium iodate, tetramethylammonium iodide, lithium perchlorate trihydrate, sodium cyanide dihydrate, sodium cyanate, potassium perchlorate, potassium nitrate, potassium iodide, potassium iodate, potassium permanganate, rubidium nitrate, rubidium iodide, cesium iodide, cesium chloride, cesium bromide, cesium perchlorate, cesium nitrate.

13. The composition of claim 1, wherein the cooling compound has an endothermic effect greater than 10 kJ/mol.

14. The composition of claim 1, wherein the cooling compound has an endothermic effect greater than 15 kJ/mol.

15. The composition of claim 1, wherein the cooling compound has an endothermic effect greater than 20 kJ/mol.

16. The composition of claim 1, wherein the absorbent material is a superabsorbent.

17. An absorbent composition comprising:
a water-swellable, water-insoluble acidic absorbent material; and
a cooling compound, wherein the cooling compound has an endothermic effect and is a basic compound capable of neutralizing the acidic absorbent material, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

18. The composition of claim 17, wherein the absorbent material has a pH ranging from 1 to 6.5, and wherein the absorbent composition has a pH ranging from 4 to 6.5.

19. The composition of claim 17, wherein the absorbent material is a superabsorbent.

20. The composition of claim 17, wherein the absorbent composition has a pH ranging from 3 to 8.

21. The composition of claim 17, wherein the absorbent composition has a pH ranging from 4 to 7.

22. An absorbent composition comprising:
a water-swellable, water-insoluble basic absorbent material; and
a cooling compound, wherein the cooling compound has an endothermic effect and is an acidic compound capable of neutralizing the basic absorbent material, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

23. The composition of claim 22, wherein the absorbent material has a pH ranging from 7.5 to 13, and wherein the absorbent composition has a pH ranging from 4 to 6.5.

24. The composition of claim 22, wherein the absorbent material is a superabsorbent.

25. The composition of claim 22, wherein the absorbent composition has a pH ranging from 3 to 8.

26. The composition of claim 22, wherein the absorbent composition has a pH ranging from 4 to 7.

27. A disposable absorbent product comprising a liquid-permeable topsheet, a liquid-impermeable backsheet attached to the topsheet, and an absorbent composition positioned between the topsheet and the backsheet, wherein the absorbent composition comprises:
a water-swellable, water-insoluble absorbent material; and
a cooling compound, wherein the cooling compound has an endothermic effect, wherein the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

28. The disposable absorbent product of claim 27, wherein the absorbent material has a pH ranging from 6 to 7.5, and wherein the absorbent composition has a pH ranging from 4 to 6.5.

29. The disposable absorbent product of claim 27, wherein the absorbent composition has a pH ranging from 3 to 8.

30. The disposable absorbent product of claim 27, wherein the absorbent composition has a pH ranging from 4 to 7.

31. The disposable absorbent product of claim 27, wherein the absorbent material is acidic, and wherein the cooling compound is a basic compound capable of neutralizing the acidic absorbent material.

32. The disposable absorbent product of claim 31, wherein the absorbent material has a pH ranging from 1 to 6.5, and wherein the absorbent composition has a pH ranging from 4 to 6.5.

33. The disposable absorbent product of claim 27, wherein the absorbent material is basic, and wherein the cooling compound is an acidic compound capable of neutralizing the basic absorbent material.

34. The disposable absorbent product of claim 33, wherein the absorbent material has a pH ranging from 7.5 to 13, and wherein the absorbent composition has a pH ranging from 4 to 6.5.

35. The disposable absorbent product of claim 27, further comprising:
a first portion including the absorbent composition; and
a second portion including a second absorbent material, such that the first portion has a net endothermic effect, and the second portion has a net exothermic hydration.

36. The disposable absorbent product of claim 27, wherein the absorbent composition exhibits an absorbent capacity of at least 70 percent of the absorbent capacity of the absorbent material.

37. The disposable absorbent product of claim 27, wherein the absorbent composition exhibits an absorbent capacity of at least 90 percent of the absorbent capacity of the absorbent material.

38. The disposable absorbent product of claim 27, wherein the absorbent composition exhibits an absorbent capacity at least equal to the absorbent capacity of the absorbent material.

39. The disposable absorbent product of claim 27, wherein the cooling compound is chosen from the group consisting of: potassium chloride, sodium acetate trihydrate, ammonium nitrate, ammonium chloride, ammonium iodate, tetramethylammonium iodide, lithium perchlorate trihydrate, sodium cyanide dihydrate, sodium cyanate, potassium perchlorate, potassium nitrate, potassium iodide, potassium iodate, potassium permanganate, rubidium nitrate, rubidium iodide, cesium iodide, cesium chloride, cesium bromide, cesium perchlorate, cesium nitrate.

40. The disposable absorbent product of claim 27, wherein the cooling compound has an endothermic effect greater than 10 kJ/mol.

41. The disposable absorbent product of claim 27, wherein the cooling compound has an endothermic effect greater than 15 kJ/mol.

42. The disposable absorbent product of claim 27, wherein the cooling compound has an endothermic effect greater than 20 kJ/mol.

43. The disposable absorbent product of claim 27, wherein the absorbent material is a superabsorbent.

44. A method for producing an absorbent composition capable of exhibiting a cooling effect, the method comprising:
selecting a water-swellable, water-insoluble absorbent material;
selecting a cooling compound having an endothermic effect; and
combining the absorbent material and the cooling compound to form the absorbent composition such that the absorbent composition exhibits an absorbent capacity of at least 10 grams of 0.9 wt % NaCl saline per gram of the absorbent composition and a cooling effect of at least a 2° C. reduction in temperature of at least a portion of the absorbent composition.

45. The method of claim 44, further comprising incorporating the combination into a disposable absorbent product.

46. The method of claim 44, further comprising selling a disposable absorbent product incorporating the combination.

47. An absorbent composition comprising:
a superabsorbent material having an exothermic heat of hydration; and
a means for adapting the absorbent composition such that the absorbent composition has a net cooling effect in at least a portion of the composition while absorbing aqueous liquid, wherein the absorbent composition exhibits an absorbent capacity of at least 10 grams of 0.9 wt % NaCl saline per gram of the absorbent composition.

48. A method for inducing a response in a wearer of a disposable absorbent product, the method comprising:
absorbing a bodily fluid in the product, wherein the product contains an absorbent composition, and wherein the absorbent composition exhibits an absorbent capacity of at least 10 grams of 0.9 wt % NaCl saline per gram of the absorbent composition;
producing a reduction in the temperature of at least a portion of the product when the portion is exposed to the bodily fluid; and
positioning the portion adjacent to the wearer such that the wearer can feel the reduction in temperature.

49. The method of claim 48, further comprising enabling the wearer to recognize and respond to internal indicators to avoid the reduction in temperature.

50. The method of claim 48, wherein the reduction in the temperature of at least a portion of the product is at least a 2° C. reduction.

51. A method for training a child, the method comprising:
providing a disposable absorbent products wherein the product contains an absorbent composition, and wherein the absorbent composition exhibits an absorbent capacity of at least 10 grams of 0.9 wt % NaCl saline per gram of the absorbent composition; and
provoking the child to recognize urination by reducing the temperature of at least a portion of the product when the portion is exposed to urine.

52. The method of claim 51, wherein the reduction in the temperature of at least a portion of the product is at least a 2° C. reduction.

53. An endothermic absorbent composition comprising:
a superabsorbent material; and
a cooling compound, wherein the endothermic absorbent composition is adapted to provide a cooling effect in at least a portion of the composition while absorbing aqueous liquid.

54. The composition of claim 53, wherein the superabsorbent material is acidic, and wherein the cooling compound is a basic compound capable of neutralizing the acidic superabsorbent material.

55. The composition of claim 54, wherein the superabsorbent material has a pH ranging from 1 to 6.5, and wherein the absorbent has a pH ranging from 4 to 6.5.

56. The composition of claim 53, wherein the absorbent material is basic, and wherein the cooling compound is an acidic compound capable of neutralizing the basic absorbent material.

57. The composition of claim 56, wherein the absorbent material has a pH ranging from 7.5 to 13, and wherein the absorbent has a pH ranging from 4 to 6.5.

58. The composition of claim 53, wherein the absorbent material has a pH ranging from 6 to 7.5, and wherein the absorbent composition has a pH ranging from 4 to 6.5.

59. The composition of claim 53, wherein the absorbent composition has a pH ranging from 3 to 8.

60. The composition of claim 53, wherein the absorbent composition has a pH ranging from 4 to 7.

61. The composition of claim 53, wherein the absorbent composition exhibits an absorbent capacity of at least 70 percent of the absorbent capacity of the absorbent material.

62. The composition of claim 53, wherein the absorbent composition exhibits an absorbent capacity of at least 90 percent of the absorbent capacity of the absorbent material.

63. The composition of claim 53, wherein the absorbent composition exhibits an absorbent capacity at least equal to the absorbent capacity of the absorbent material.

64. The composition of claim 53, wherein the cooling compound is chosen from the group consisting of: potassium chloride, sodium acetate trihydrate, ammonium nitrate, ammonium chloride, ammonium iodate, tetramethylammonium iodide, lithium perchlorate trihydrate, sodium cyanide dihydrate, sodium cyanate, potassium perchlorate, potassium nitrate, potassium iodide, potassium iodate, potassium permanganate, rubidium nitrate, rubidium iodide, cesium iodide, cesium chloride, cesium bromide, cesium perchlorate, cesium nitrate.

65. The composition of claim 53, wherein the cooling compound has an endothermic effect greater than 10 kJ/mol.

66. The composition of claim 53, wherein the cooling compound has an endothermic effect greater than 15 kJ/mol.

67. The composition of claim 53, wherein the cooling compound has an endothermic effect greater than 20 kJ/mol.

68. An absorbent composition comprising:
a superabsorbent material having an exothermic heat of hydration; and
a cooling compound having an endothermic effect, wherein the absorbent composition is adapted to provide a cooling effect in at least a portion of the composition while absorbing aqueous liquid.

69. The composition of claim 68, wherein the superabsorbent material is acidic, and wherein the cooling compound is a basic compound capable of neutralizing the acidic superabsorbent material.

70. The composition of claim 69, wherein the superabsorbent material has a pH ranging from 1 to 6.5, and wherein the absorbent has a pH ranging from 4 to 6.5.

71. The composition of claim 68, wherein the absorbent material is basic, and wherein the cooling compound is an acidic compound capable of neutralizing the basic absorbent material.

72. The composition of claim 71, wherein the absorbent material has a pH ranging from 7.5 to 13, and wherein the absorbent has a pH ranging from 4 to 6.5.

73. The composition of claim 68, wherein the absorbent material has a pH ranging from 6 to 7.5, and wherein the absorbent composition has a pH ranging from 4 to 6.5.

74. The composition of claim 68, wherein the absorbent composition has a pH ranging from 3 to 8.

75. The composition of claim 68, wherein the absorbent composition has a pH ranging from 4 to 7.

76. The composition of claim 68, wherein the absorbent composition exhibits an absorbent capacity of at least 70 percent of the absorbent capacity of the absorbent material.

77. The composition of claim 68, wherein the absorbent composition exhibits an absorbent capacity of at least 90 percent of the absorbent capacity of the absorbent material.

78. The composition of claim 68, wherein the absorbent composition exhibits an absorbent capacity at least equal to the absorbent capacity of the absorbent material.

79. The composition of claim 68, wherein the cooling compound is chosen from the group consisting of: potassium chloride, sodium acetate trihydrate, ammonium nitrate, ammonium chloride, ammonium iodate, tetramethylammonium iodide, lithium perchlorate trihydrate, sodium cyanide dihydrate, sodium cyanate, potassium perchlorate, potassium nitrate, potassium iodide, potassium iodate, potassium permanganate, rubidium nitrate, rubidium iodide, cesium iodide, cesium chloride, cesium bromide, cesium perchlorate, cesium nitrate.

80. The composition of claim 68, wherein the cooling compound has an endothermic effect greater than 10 kJ/mol.

81. The composition of claim 68, wherein the cooling compound has an endothermic effect greater than 15 kJ/mol.

82. The composition of claim 68, wherein the cooling compound has an endothermic effect greater than 20 kJ/mol.

83. An absorbent composition comprising:
a superabsorbent material; and
a sufficient amount of cooling compound such that the absorbent composition is adapted to provide a cooling effect in at least a portion of the composition while absorbing aqueous liquid.

84. The composition of claim 83, wherein the superabsorbent material is acidic, and wherein the cooling compound is a basic compound capable of neutralizing the acidic superabsorbent material.

85. The composition of claim 84, wherein the superabsorbent material has a pH ranging from 1 to 6.5, and wherein the absorbent has a pH ranging from 4 to 6.5.

86. The composition of claim 83, wherein the absorbent material is basic, and wherein the cooling compound is an acidic compound capable of neutralizing the basic absorbent material.

87. The composition of claim 86, wherein the absorbent material has a pH ranging from 7.5 to 13, and wherein the absorbent has a pH ranging from 4 to 6.5.

88. The composition of claim 83, wherein the absorbent material has a pH ranging from 6 to 7.5, and wherein the absorbent composition has a pH ranging from 4 to 6.5.

89. The composition of claim 83, wherein the absorbent composition has a pH ranging from 3 to 8.

90. The composition of claim 83, wherein the absorbent composition has a pH ranging from 4 to 7.

91. The composition of claim 83, wherein the absorbent composition exhibits an absorbent capacity of at least 70 percent of the absorbent capacity of the absorbent material.

92. The composition of claim 83, wherein the absorbent composition exhibits an absorbent capacity of at least 90 percent of the absorbent capacity of the absorbent material.

93. The composition of claim 83, wherein the absorbent composition exhibits an absorbent capacity at least equal to the absorbent capacity of the absorbent material.

94. The composition of claim 83, wherein the cooling compound is chosen from the group consisting of: potassium chloride, sodium acetate trihydrate, ammonium nitrate, ammonium chloride, ammonium iodate, tetramethylammonium iodide, lithium perchlorate trihydrate, sodium cyanide dihydrate, sodium cyanate, potassium perchlorate, potassium nitrate, potassium iodide, potassium iodate, potassium permanganate, rubidium nitrate, rubidium iodide, cesium iodide, cesium chloride, cesium bromide, cesium perchlorate, cesium nitrate.

95. The composition of claim 83, wherein the cooling compound has an endothermic effect greater than 10 kJ/mol.

96. The composition of claim 83, wherein the cooling compound has an endothermic effect greater than 15 kJ/mol.

97. The composition of claim 83, wherein the cooling compound has an endothermic effect greater than 20 kJ/mol.
